(19) United States
(12) Patent Application Publication
(10) Pub. No.: US 2024/0360886 A1
(43) Pub. Date: Oct. 31, 2024

(54) VIBRATION DAMPER WITH AN ADJUSTABLE DAMPING VALVE DEVICE

(71) Applicant: ZF Friedrichshafen AG, Friedrichshafen (DE)

(72) Inventor: Artur SCHELL, Bad Neustadt a. d. Saale (DE)

(21) Appl. No.: 18/645,913

(22) Filed: Apr. 25, 2024

(30) Foreign Application Priority Data
Apr. 27, 2023 (DE) 10 2023 203 913.3

(51) Int. Cl. F16F 9/53

(52) U.S. Cl. CPC F16F 9/537

(57) ABSTRACT

Vibration damper having an adjustable damping valve device comprising an actuator having a magnetic coil that applies a magnetic actuation force to an axially movable valve armature within a sleeve-like fixed return member that includes a conductive portion and an insulating portion. The return member cooperates with a pole disk that conducts a magnetic flux of the magnetic coil and on which an axial transfer of the magnetic flux for the actuating movement of the valve armature takes place. The insulating portion of the return member is adjoined in the direction of the pole disk by a second conductive portion and the valve armature axially overlaps the second conductive portion depending on the stroke.

### BACKGROUND OF THE INVENTION

### 1. Field of the Invention

The disclosure relates to a vibration damper having an adjustable damping valve device.

### 2. Description of Related Art

DE 10 2013 218 658 A1 discloses a generic vibration damper, the damping valve device of which can be adjusted by an electromagnetic actuator. The actuator comprises a magnetic coil which applies a magnetic actuating force to a valve armature. The valve armature is guided in an axially movable manner in a return member. In this instance, the return member comprises a base, which forms a part-region of a cover for the damping valve device. A sleeve portion of the return member acts as a conductor for the magnetic flux of the magnetic coil. The sleeve portion comprises a conductive portion and an insulating portion. The insulating portion acts as a resistor and ensures a radial transfer of the magnetic flux from the conductive portion of the return member to the valve armature.

An end, opposite the base, of the insulating portion of the return member is axially connected to an annular magnetically conductive pole disk. The insulating portion extends radially between an outer step of the insulating portion and a magnetically conductive housing portion of the damping valve device.

The insulating portion is in this variant formed by a metal sleeve, which is connected in a materially engaging manner, for example, by soldering, to the conductive portion. The metal sleeve may, for example, comprise high-grade steel.

An alternative embodiment of an insulator within an adjustable damping valve device is, for example, known from DE 196 24 898 A1. In this instance, an elastomer ring is used as an insulator.

Both in DE 10 2013 218 658 A1 and in DE 196 24 898 A1, an end of the valve armature facing in the direction of the pole disk always moves regardless of the power applied to the magnetic coil in the radial covering region with the insulating portion. It is thereby ensured that the entire magnetic flux flows through the valve armature and axially further through the pole disk which has direct contact with the conductive housing portion.

In practice, as a result of this construction principle, constant path/force characteristic lines which, depending on the power supplied to the magnetic coil, form a characteristic field with parallel constants are produced. For use in an actuator, therefore, return springs counter to which the magnetic force of the magnetic coil acts on the valve armature are often used.

### SUMMARY OF THE INVENTION

An aspect of the present invention is to develop an actuator of a damping valve device in such a manner that the path/force characteristic line has a positive inclination.

One aspect of the invention is an insulating portion of the return member that is adjoined in the direction of the pole disk by a second conductive portion and the valve armature axially that overlaps the second conductive portion depending on the stroke.

As a result of the combination of an insulating portion and a second conductive portion, a targeted influence can be applied to the magnetic flux of the magnetic coil in order to define the path/force function of the actuator.

In one aspect of the invention, the second conductive portion of the return member has a magnetic conductivity which increases in the direction of the pole disk. If the valve armature approaches in the direction of the pole disk, the magnetic flux over this path would significantly increase. The second conductive portion of the return member compensates for this magnetic flux by the second conductive portion providing a parallel flow path for the magnetic flux.

Preferably, the second conductive portion of the return member forms a magnetic flux path which is parallel with the pole disk to a housing portion which conducts the magnetic flux. This configuration leads to the advantage that the second conductive portion of the return member requires no contact with the pole disk for the magnetic conductive function thereof.

With regard to a simple production and a non-critical durability, the conductive portion and the insulating portion of the return member are configured in a seamless manner. The term “seamless” is intended to be understood in the sense of homogeneous or in one piece.

In this instance, the insulating portion is formed quite simply by a cross sectional reduction of the return member. According to one aspect of the invention, the cross sectional reduction is formed by a groove.

In this instance, the groove is preferably configured on the outer circumference of the return member since an outer groove can be produced in a simpler manner than an inner groove and with an outer groove there is no interruption within a guiding face on the return member for the valve armature.

Furthermore, a transition region between the insulating portion and the second conductive portion of the return member has in the direction of the second conductive portion a cross sectional increase. Preferably, the cross sectional increase is formed by a cone.

An additional measure for influencing the force/path characteristic of the actuator involves the pole disk having an axial projection and the valve armature having an annular space for receiving the projection when approaching the pole disk so that, depending on the stroke position of the valve armature with respect to the pole disk, there is an axial overlap between the valve armature and the pole disk. The axial overlap leads to a radial magnetic flux which also produces a vertical force component on the valve armature.

To this end, there is provision for the axial projection of the pole disk to have a conical shape in the direction of the valve armature.

### BRIEF DESCRIPTION OF THE DRAWINGS

The invention will be explained in greater detail with reference to the following description of the Figures.

In the drawings:

FIG. 1 is a damping valve device on a vibration damper,

FIG. 2 is a sectioned illustration of the damping valve device,

### DETAILED DESCRIPTION OF THE PRESENTLY PREFERRED EMBODIMENTS

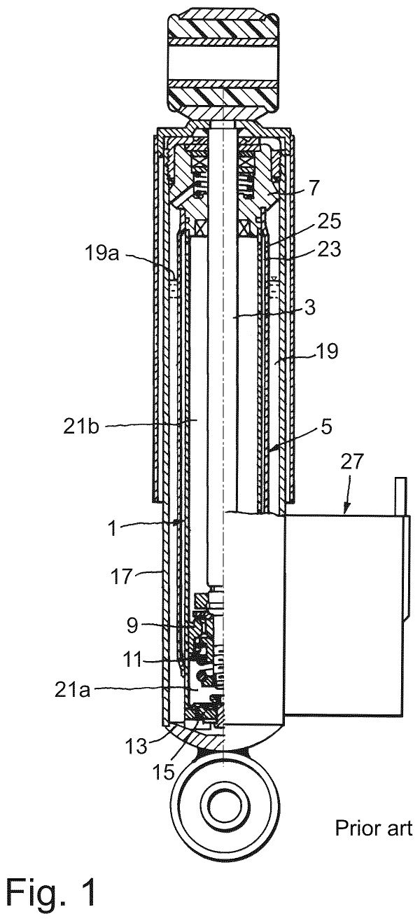

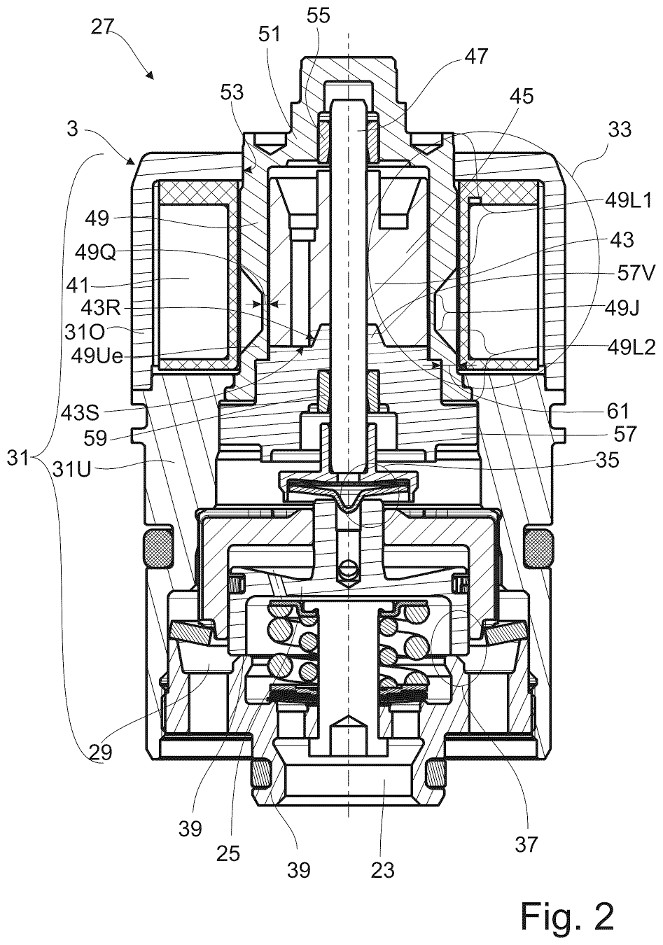

In FIG. 1, a vibration damper has a cylinder 1 in which a piston rod 3 is arranged so as to be axially movable. A guiding and sealing unit 7 guides the piston rod 3 out of the upper end of the cylinder. Within the cylinder 1, on the piston rod 3 a piston unit 9 is secured with a piston valve arrangement 11. The lower end of the cylinder 1 is closed by a base plate 13 having a base valve arrangement 15. The cylinder 1 is surrounded by a container pipe 17. The container pipe 17 and an intermediate pipe 5 form an annular space 19 which represents a compensation chamber. The space inside the cylinder 1 is subdivided by the piston unit 9 into a first working chamber 21a and a second working chamber 21b. The working chambers 21a and 21b are filled with damping fluid. The compensation chamber 19 is filled up to the level 19a with fluid and above that with gas. Within the compensation chamber 19 there is formed a first guiding path, that is to say, a high-pressure part-path 23 which is connected via a hole 25 of the cylinder 1 to the second working chamber 21b. This high-pressure part-path is adjoined by an adjustable damping valve device 27 which is fitted laterally on the container pipe 17. From this, a second guiding path, that is to say, a low-pressure part-path 29, see FIG. 2, leads into the compensation chamber 19.

If the piston rod 3 moves out of the cylinder 1 in an upward direction, the upper working chamber 21b is reduced. An excess pressure is formed in the upper working chamber 21b and can only be reduced by the piston valve arrangement 11 in the lower working chamber 21a if the adjustable damping valve 27 is closed. When the adjustable damping valve device 27 is opened, at the same time fluid flows from the upper working chamber 21b through the high-pressure part-path 23 and the adjustable damping valve device 27 into the compensation chamber 19. The damping characteristic of the vibration damper when extending the piston rod 3 is thus dependent on whether the adjustable damping valve device 27 is open or closed to a greater or lesser extent.

When the piston rod 3 moves into the cylinder 1, an excess pressure is formed in the lower working chamber 21a. Fluid can move from the lower working chamber 21a through the piston valve arrangement 11 upward into the upper working chamber 21b. The fluid which is displaced by the increasing piston rod volume within the cylinder 1 is expelled by the base valve arrangement 15 into the compensation chamber 19. In the upper working chamber 21b, since the throughflow resistance of the piston valve arrangement 11 is lower than the throughflow resistance of the base valve arrangement 15, an increasing pressure is also produced. This increasing pressure can, when the damping valve device 27 is opened, flow through the high-pressure part-path 23 into the compensation space 19 again. This means that, when the damping valve device 27 is open, the vibration damper even when being retracted then has a softer characteristic when the adjustable damping valve device 27 is opened and a harder characteristic when the damping valve device 27 is closed, in the same manner as when the piston rod is extended. It may be noted that the flow direction through the high-pressure part-path 23 of the bypass is always the same, regardless of whether the piston rod is retracted or extended.

FIG. 2 shows the damping valve device 27 as a sub-assembly. In a valve housing 31, a magnetic actuator 33 for actuating a preliminary stage valve 35 is arranged. With the preliminary stage valve 35, a main stage valve is controlled in order to produce the damping force. The main structure of the preliminary stage valve and the main stage valve is, for example, known from DE 10 2013 218 658 A1. The description relating to the valve structure from DE 10 2013 218 658 A1 should also be part of this description.

In this embodiment, the valve housing 31 is constructed in two pieces. In a lower valve housing 31U, the preliminary stage valve 35 and the main stage valve 37 are arranged. A connection nozzle 39 forms the connection between the high-pressure portion path 23 (FIG. 1) and the main stage valve 37. The lower valve housing 31U is preferably welded to the container pipe 17. In principle, the damping valve device may, for example, also be used as an external structural unit or on the piston rod.

There is arranged in an upper valve housing 310 the magnetic actuator 33 which comprises a magnetic coil 41 which applies a magnetic actuating force to an axially movable valve armature 43. The valve armature 43 has an annular conducting member 45 having a center axle 47 on which the preliminary stage valve engages. The use of a preliminary stage valve or maintaining a specific construction type of the main stage valve are not absolutely necessary to the invention.

The valve armature 43 is guided radially to a fixed sleeve-like return member 49. A base 51 of the return member 49 closes a central opening 53 of the upper valve housing 31O. In the base 51, a first bearing location 55 for the radial support of the axle 47 of the valve member 43 is also arranged.

The return member 49 cooperates with an annular pole disk 57 which conducts a magnetic flux, indicated by a dot-dash line, of the magnetic coil 41 and at which an axial transfer of the magnetic flux for the actuating movement of the valve armature 43 takes place. The pole disk 57 has a second bearing location 59 for the axle 47 of the valve member 43 and forms an intermediate wall between the upper and lower valve housing 31U; 31O.

The return member 49 comprises a plurality of functional portions. A first portion 49L1 which conducts the magnetic flux extends from the base 51 in the direction of the pole disk 57. Regardless of the stroke position of the valve armature relative to the pole disk 57 or the first conductive portion 49L1 of the return member 49, there is between the first conductive portion 49L1 and the valve armature 43 a large axial overlap so that in this region there is always a significant conductivity for the magnetic flux. In this instance, the first conductive portion 49L1 has a constant annular cross section and consequently a constant conductivity for the magnetic flux.

The first conductive portion 49L1 of the return member 49 is adjoined by an insulating portion 49l. The insulating action or the significant resistance against a magnetic flux is achieved in that the insulating portion 49l is formed by a cross sectional reduction 49Q of the return member 49. The cross sectional reduction 49Q is, for example, formed by a circumferential groove which is configured on the outer circumference of the return member 49.

The insulating portion 49l of the return member 49 is adjoined in the direction of the pole disk 57 by a second conductive portion 49L2 so that a conductive portion of the return member 49 is active at both ends of the magnetic coil 41. As can be seen in FIG. 2, the valve armature 43 radially overlaps the second conductive portion depending on the stroke.

The second conductive portion 49L2 of the return member 49 does not have over the entire length thereof a cross section in the manner of the first conductive portion 49L1 but instead has a magnetic conductivity that increases in the direction of the pole disk 57.

It can further be seen in FIG. 2 that the second conductive portion 49L2 of the return member 49 forms a magnetic flux path 61 which is parallel with the pole disk 57 to a housing portion, which conducts the magnetic flux, in the exemplary embodiment the lower valve housing 31U.

In spite of the different functional portions 49L1; 49I; 49L2, the conductive portion 49L1 and the insulating portion 49I of the return member 49 are configured in a seamless manner. The second conductive portion 49L2 is also connected in an integral manner to the two other functional portions 49L1; 49I. A materially engaging connection between the portions 491; 49L2 is consequently not present.

A transition region 49Ue between the insulating portion 49l and the second conductive portion 49L2 of the return member 49 in the direction of the second conductive portion 49L2 further has a cross sectional increase in order to increase the magnetic conductivity within the return member 49. An increased magnetic conductivity in the second conductive portion 49L2 results in a reduced magnetic flux passing between an end face 43S of the valve armature 43 and the pole disk 57 and consequently also a smaller magnetic actuation force being effective.

In addition to the second conductive portion 49L2 on the return member 49, the actuator 33 has as an additional measure for influencing the path/force characteristic line an axial projection 57V on the pole disk 57. To this end, the valve armature 43 has an annular space 43R for receiving the projection 57V when approaching the pole disk 57 so that, depending on the stroke position of the valve armature 43 with respect to the pole disk 57, an axial overlap between the valve armature and the pole disk is present. The projection 57V on the pole disk 57 is not in the form of a simple step, but instead has a conical form in the direction of the valve armature 43. When the valve armature 43 approaches the conical projection 57V of the pole disk 57, there is at this location a magnetic flux which, however, only partially brings about an axial actuation force on the valve armature 43.

Via the relative axial position of the projection 57V on the pole disk 57 in the direction of the valve armature 43 with respect to the axial position of the second conductive portion 49L2 of the return member 49, the effective magnetic flux from the valve armature 43 to the pole disk 57 can be sized. The cone angle of the projection 57V and the profile at the transition region 49Ue also act on the characteristic line of the actuator 33. The greater the axial overlap between the valve armature 43 and the second conductive portion 49L2 is, the greater is the proportion of the magnetic flux on this path and the smaller is the remaining portion of the magnetic flux between the valve armature 43 and the pole disk 57. Depending on the structural spaces for the valve armature, the return member and the magnetic coil, by variation of the parameters mentioned the path/force characteristic line may increase practically in a horizontally extending manner or also in a linear or progressive manner.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A vibration damper having an adjustable damping valve device comprising:
a sleeve-like fixed return member that comprises a conductive portion and an insulating portion;
an valve armature that is axially movable within the sleeve-like fixed return member; and
an actuator having a magnetic coil configured to apply a magnetic actuation force to the valve armature;
wherein the sleeve-like fixed return member cooperates with a pole disk that conducts a magnetic flux of the magnetic coil and on which an axial transfer of the magnetic flux for actuating movement of the valve armature takes place, and
wherein the insulating portion of the sleeve-like fixed return member is adjoined in a direction of the pole disk by a second conductive portion and the valve armature axially overlaps the second conductive portion depending on a stroke.

2. The vibration damper as claimed in claim 1, wherein the second conductive portion of the sleeve-like fixed return member has a magnetic conductivity that increases in the direction of the pole disk.

3. The vibration damper as claimed in claim 1, wherein the second conductive portion of the sleeve-like fixed return member forms a magnetic flux path parallel with the pole disk to a housing portion that conducts the magnetic flux.

4. The vibration damper as claimed in claim 1, wherein the conductive portion and the insulating portion of the sleeve-like fixed return member are configured in a seamless manner.

5. The vibration damper as claimed in claim 1, wherein the insulating portion is formed by a cross sectional reduction of the sleeve-like fixed return member.

6. The vibration damper as claimed in claim 5, wherein the cross sectional reduction is formed by a groove.

7. The vibration damper as claimed in claim 6, wherein the groove is configured on an outer circumference of the sleeve-like fixed return member.

8. The vibration damper as claimed in claim 1, wherein a transition region between the insulating portion and the second conductive portion of the sleeve-like fixed return member has in a direction of the second conductive portion a cross sectional increase.

9. The vibration damper as claimed in claim 1, wherein the pole disk has an axial projection and the valve armature has an annular space configured to receive the axial projection when approaching the pole disk so that, depending on the stroke position of the valve armature with respect to the pole disk, there is an axial overlap between the valve armature and the pole disk.

10. The vibration damper as claimed in claim 9, wherein the axial projection of the pole disk has a conical shape in the direction of the valve armature.
